(19) United States
(12) Patent Application Publication
(10) Pub. No.: US 2016/0325876 A1
(43) Pub. Date: Nov. 10, 2016

(54) STRUCTURE OF A ONE-PIECE PAPER CONTAINER AND THE MANUFACTURING PROCESS THEREOF

(71) Applicant: MASTER PAPER CONTAINER CORP., FLUSHING, NY (US)

(72) Inventors: QIUYU ZHOU, DENVER, CO (US); DANIEL CHIEN, VALLEY STREAM, NY (US); HSIN-HUNG CHOU, TAIPEI CITY 106 (TW)

(21) Appl. No.: 14/704,155

(22) Filed: May 5, 2015

(51) Int. Cl. B65D 5/56; B29C 51/26; B65D 5/66; B29C 65/02; B29C 51/08; B65D 5/00; B29C 51/00; B29C 65/00

(52) U.S. Cl. CPC B65D 5/563; B29C 51/002; B29C 51/264; B29C 66/45; B29C 65/02; B29C 51/082; B65D 5/0085; B65D 5/6697; B29K 2001/00

(57) ABSTRACT

A one-piece paper container is formed by cutting and pressing a single-layer coated paper into an unfolded container body and cover, then steaming to soften one of the surfaces thereof and thermoforming with an upper and lower moldings at 120° C.˜160° C., combining a coating film covering on a plurality of coincided surfaces at the corners and forming enhanced surfaces with protrusions at on the container body and the cover in the meantime, therefore forming a strong structure. Finally, conducting a moisture examination to decide if the product is qualified or not, so as to ensure safety for the consumers.

### BACKGROUND OF THE INVENTION

1. Field of the Invention:

The present invention relates to a structure of a one-piece paper container and the manufacturing process thereof, particularly to one that has an extendable container base by steaming to form a paper container with strong structure.

2. Description of the Related Art:

Conventional disposable trays are usually made of plastics, polystyrene, or paper pulp, among which the one made of polystyrene would release toxic substances that are harmful to human body when being exposed to heat; plus, it cannot be decomposed by the nature environment. Therefore, it is forbidden to use polystyrene as the materials for disposable trays.

Therefore, the needs for disposable trays made of paper pulp are increasing, bringing about many different kind of disposable trays made of paper pulp. The structures of conventional paper trays are illustrated in FIGS. 1A and 1B. A base 60 of the tray is shaped by cutting a paperboard. The base 60 includes a bottom 61, a plurality of peripheral boards 62, a plurality of folding pieces 63, and a cover 64, all of which are connecting together; and the folding pieces 63 would coincide after thermoforming, forming a paper tray container 60A.

However, the structure of the paper tray container 60A has a problem that the container body 61a and the cover 64a are not extendable after thermoforming; therefore, it cannot form any protrusions on the surfaces like the plastic or polystyrene tray containers. Such structure may deform when the tray container is filled with hot food. Also, the folding pieces 63 are coincided by adhesives, which is not strong enough either. The tray container may be damaged or even fall apart if someone tries to pull from both sides, and this would cause leakage when the tray container has sauces with food filled therein. Therefore, there is still room for improvements.

### SUMMARY OF THE INVENTION

It is a primary object of the present invention to provide a one-piece paper container to solve the problems in the prior art by a strong structure formed in one-piece, in order to replace the conventional containers made of unrecyclable materials and ensure more safety in food consumption.

Another object of the present invention is to provide a one-piece paper container that has an extendable container base by steaming, and when the paper container is shaped, the moisture thereof is the measurement to decide if it is qualified, ensuring both quality of the products and safety for the consumers.

In order to achieve the objects mentioned above, the manufacturing process of the present invention comprises the following steps: a) providing a single-layer coated paper formed by having a PE coating film coated on a first surface of a base paper and leaving a second surface of the base paper exposed; b) cutting and pressing said single-layer coated paper into an unfolded container base with a container body and a cover; c) providing a steam room for the cut unfolded container base to be disposed therein, for the second surface of the base paper to absorb the steam and therefore soften the container base; d) providing a thermoforming equipment to form the prototype of the container body, the cover, and a plurality of coincided surfaces at four corners to coincide and shape the container base; e) providing an upper mold and a lower mold having depression surfaces with a pre-determined depth for thermoforming at 120° C.˜160° C. and fusing the coating film on the coincided surfaces with heat to combine with each other; f) holding control of the period for thermoforming so that when the container body and the cover are shaped, an enhanced surface with a plurality of protrusions would form on each of the surfaces thereof; and g) shaping the one-piece paper container and measuring the moisture thereof to decide if it is qualified.

In step b), the unfolded container base comprises a container body including a bottom and four peripheral surfaces extending from each edge of the bottom with the edge having dotted lines and each adjacent side of the peripheral surfaces being arranged as a cut line at an oblique angle for coinciding and forming round corners of the container body; a cover including a covering surface and four peripheral surfaces extending from each edge of the covering surface with the edge having dotted lines and each adjacent side of the peripheral surfaces being arranged as a cut line at an oblique angle for coinciding and forming round corners of the cover; and a linking dotted lines arranged at the rear of the container body and the cover.

The one-piece paper container made in the manufacturing process above comprises a container base formed by cutting and pressing a single-layer coated paper, including a container body and a cover; the single-layer coated paper is formed by having a first surface of a base paper coated on a PE coating film and leaving a second surface of the base paper exposed; the container body having a bottom and four peripheral surfaces extending upwards from the edges of the bottom and being coincided to form the container body; the cover having a covering surface and four peripheral surfaces extending downwards from the edges of the covering surface and being coincided to form the cover, and having a linked lifting portion arranged at the rear of the cover and the container body for the cover to be lifted from or covered on the container body; wherein the coincided surfaces at the corners of the container base are formed by fusing the coating film thereon with heat; both the covering surface of the cover and the bottom of the container body having enhanced surfaces with a plurality of protrusions formed in one-piece.

With structures disclosed above, the present invention has the container base to be extendable by steaming which has enhanced surfaces with protrusions formed in the molding process, featuring itself a strong structure. Meanwhile, there is a measurement of moisture to decide whether the shaped paper container is qualified for usage or not, ensuring the quality of the products and also more safety for the consumers, and efficiently overcoming the problems in the prior art.

### BRIEF DESCRIPTION OF THE DRAWINGS

FIG. 1A is a schematic diagram of the structure of a conventional paper container;

FIG. 1B is a schematic diagram of the structure of another conventional paper container;

FIG. 2 is a flow diagram illustrating the manufacture process of the present invention;

FIG. 3 is a schematic diagram of an unfolded container base of the present invention;

FIG. 4 is a schematic diagram illustrating the container base of the present invention absorbing the steam to soften the surface thereof;

FIG. 5 is a schematic diagram illustrating the thermoforming process of the present invention in an embodiment;

FIG. 6 is a schematic diagram illustrating the preliminary shaping of the container body and the cover of the present invention;

FIG. 7 is a perspective view of the present invention; and

FIG. 8 is an application example of the present invention.

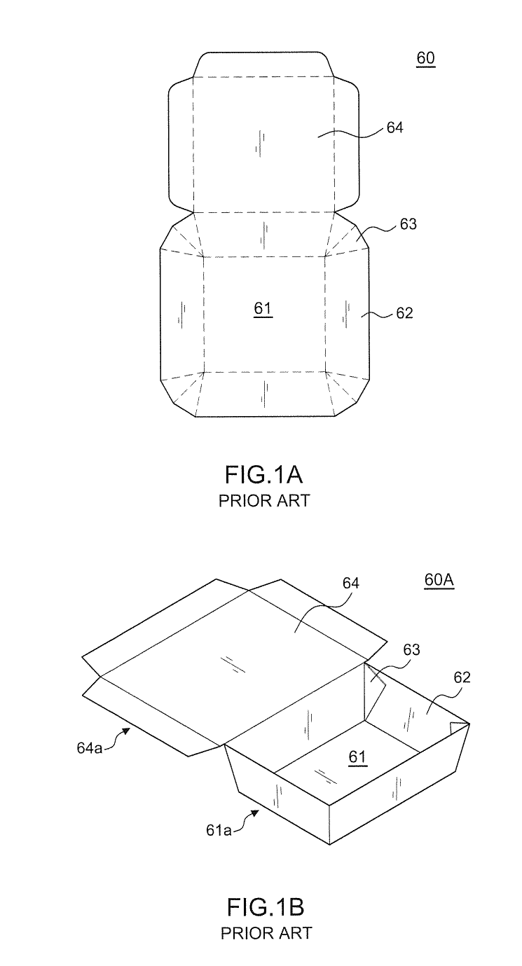

### DETAILED DESCRIPTION OF THE PREFERRED EMBODIMENT

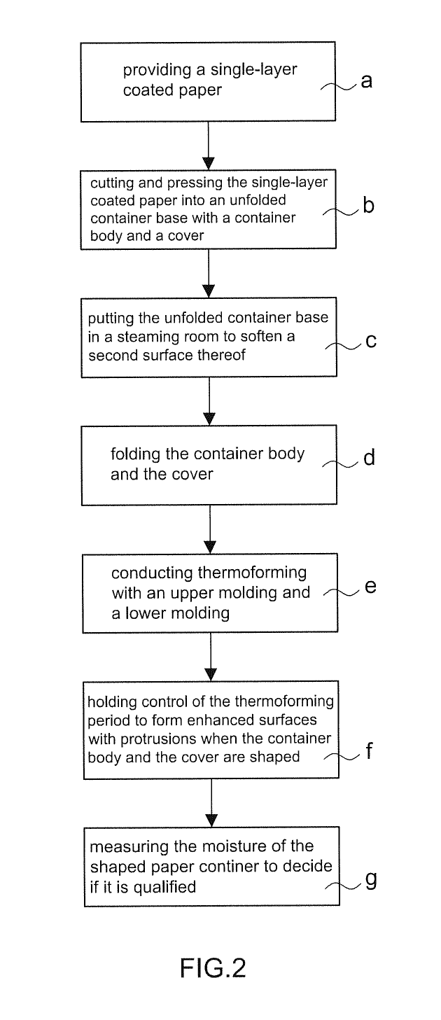

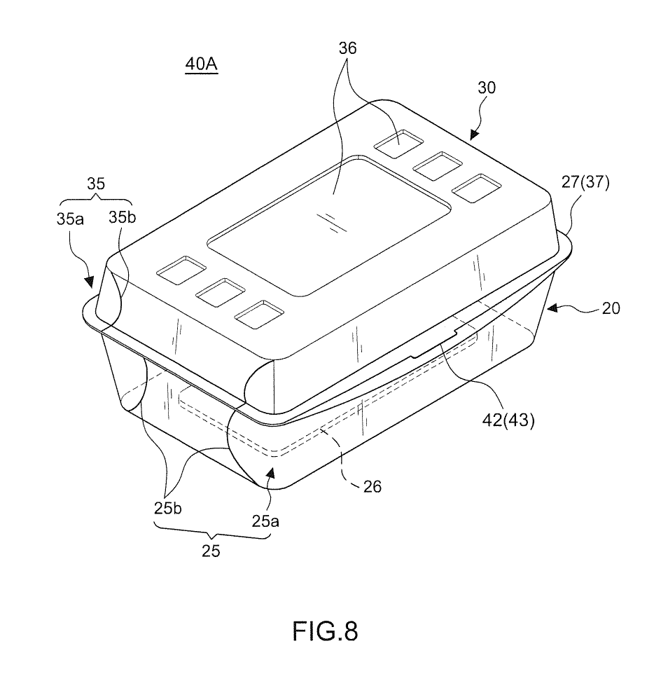

Referring to FIGS. 2-8, in an embodiment, the manufacturing process of a one-piece paper container comprises steps as below.

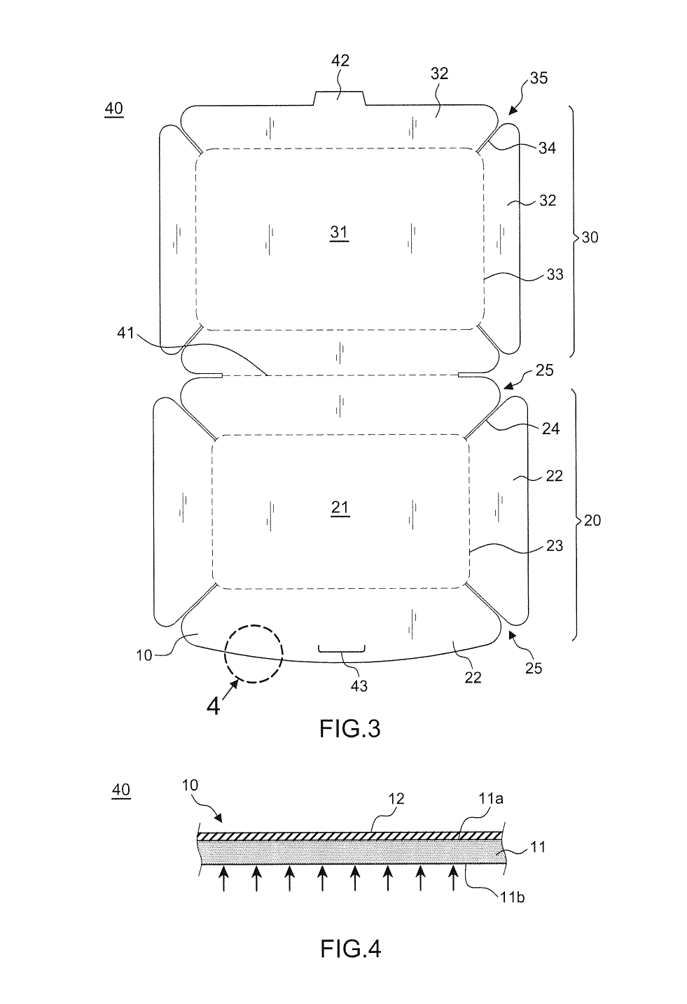

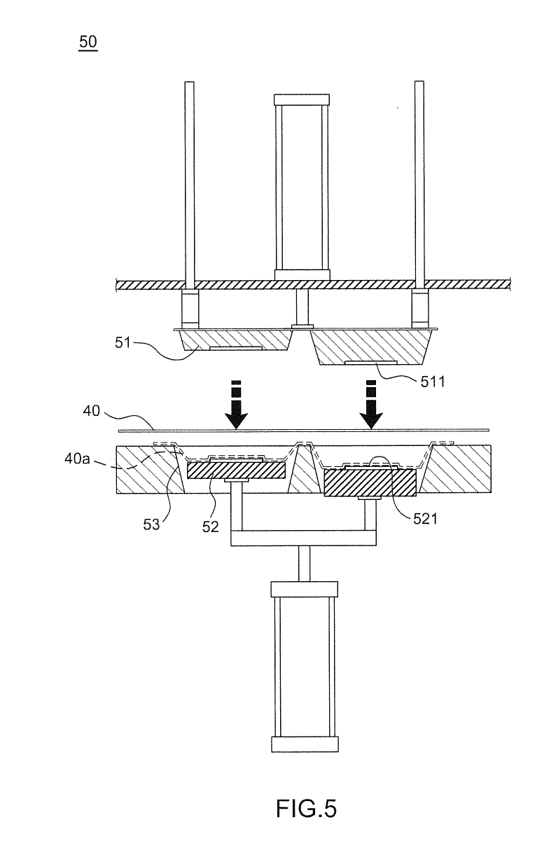

Step a: providing a single-layer coated paper 10 formed by having a PE coating film 12 coated on a first surface 11a of a base paper 11 and leaving a second surface 11b of the base paper 11 exposed as shown in FIGS. 3 and 4. In this embodiment, the exposed second surface 11b is for a later steaming process to absorb the steam and become soften.

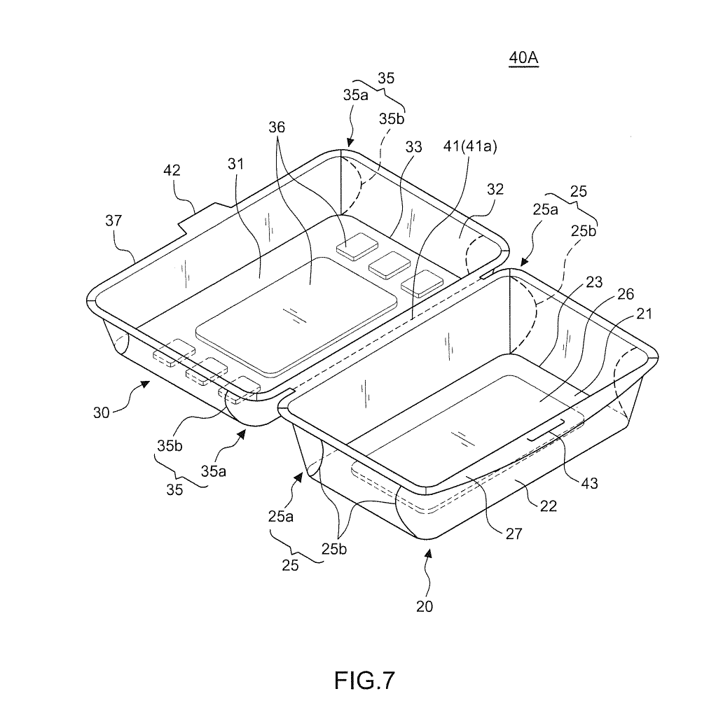

Step b: cutting and pressing said single-layer coated paper 10 into an unfolded container base 40 with a container body 20 and a cover 30. Referring to FIG. 3, in this embodiment, the unfolded container base 40 comprises a container body 20 including a bottom 21 and four peripheral surfaces 22 extending from each edge of the bottom 21 with the edge having dotted lines 23 and each adjacent side of the peripheral surfaces 22 being arranged as a cut line 24 at an oblique angle for coinciding and forming round corners 25a of the container body 20 as shown in FIG. 7; a cover 30 including a covering surface 31 and four peripheral surfaces 32 extending from each edge of the covering surface 31 with the edge having dotted lines 33 and each adjacent side of the peripheral surfaces 32 being arranged as a cut line 34 at an oblique angle for coinciding and forming round corners 35a of the cover 30 as shown in FIG. 7; and a linking dotted lines 41 arranged at the rear of the container body 20 and the cover 30. Furthermore, the cover 30 has a tab 42 arranged at one side but the rear, and the container body 20 has a slash 43 arranged at the same side as the tab 42 for engagement to firmly close the paper container.

Step c: providing a steam room (not shown) for the cut unfolded container base 40 to be disposed therein, for the second surface 11b of the base paper 11 to absorb the steam as shown in FIG. 4 and therefore soften the container base 40. The first surface 11a has the coating film 12 thereon and thus is unable to absorb the steam; this is one of the important elements of the present invention since the coating film 12 will be the contact surface with the food when the paper container is used later.

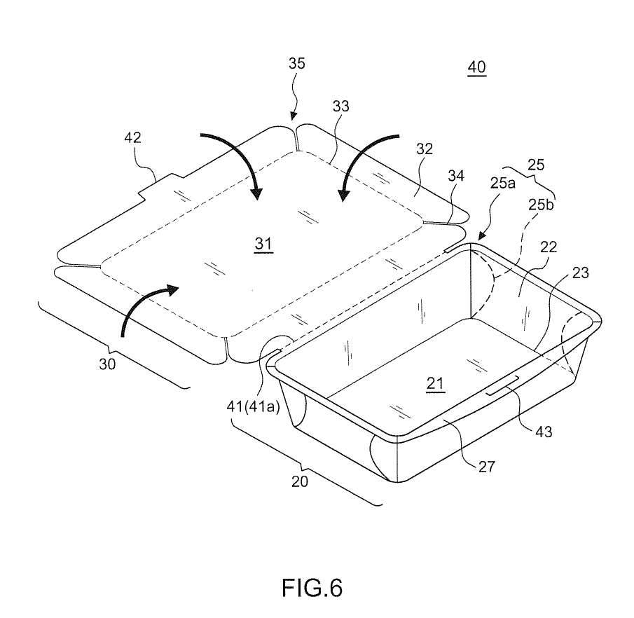

Step d: referring to FIG. 5, providing a thermoforming equipment 50 to form the prototype of the container body 20 and the cover 30, as shown in the broken lines 40a. In this embodiment, the thermoforming equipment 50 belongs to the prior art and only illustrates an applicable embodiment to form the container body 20 and the cover 30. Each of the four corners 25, 35 has the edges thereof arranged as a cut line 24 for coinciding a plurality of coincided surfaces 25b, 35b later as shown in FIG. 7. FIG. 6 illustrates a folded container body 20 and an unfolded cover 30; however, both the container body 20 and the cover 30 can be folded in the thermoforming process.

Step e: providing an upper mold 51 and a lower mold 52 having depression surfaces 511, 521 with a pre-determined depth. In this embodiment, the upper and lower mold 51, 52 have electric heating elements thereon (not shown) to reach a pre-determined degree of temperature between 120° C. and 160° C. for thermoforming and fusing the coating film 12 on the coincided surfaces 25b, 35b at the corners 25, 35 with heat to combine with each other. In other words, the present invention does not require adhesives to fix the coincided surfaces 25b, 35b; the coating film 12 thereon would become adhesive by the heating and therefore combine with the coincided surfaces 25b, 35b. The temperature for thermoforming has to be under 160° C., or the coating film 12 would be tampered.

Step f: holding control of the period for thermoforming so that when the container body 20 and the cover 30 are shaped, an enhanced surface 26, 36 with a plurality of protrusions would form on each of the surfaces thereof. In this embodiment, the container body 20 and the cover 30 further have horizontal flange surfaces 27, 37 extending from the edges thereof in the thermoforming process, as shown in FIG. 7.

Step g: shaping the one-piece paper container 40A and taking it out from the molds 51, 52, then measuring the moisture thereof to decide if it is qualified. This step is an important feature of the present invention. If the moisture of the shaped one-piece paper container 40A is higher than a pre-determined number, the coincided surfaces 25b, 35b would not be fixedly attached, and may be unfolded when contacting with hot foods. In this case, it should be categorized as unqualified. Such categorization can only be achieved by the moisture examination with much higher accuracy according to actual testing. The quality of the present invention is therefore guaranteed.

With the manufacturing process disclosed above, the one-piece paper container 40A comprises a container body 20 having a bottom 21 and four peripheral surfaces 22 extending upwards from the edges of the bottom 21 and being coincided to form the container body 20, and a cover 30 having a covering surface 31 and four peripheral surfaces 32 extending downwards from the edges of the covering surface 31 and being coincided to form the cover 30. At the rear of the cover 30 and the container body 20, a linked lifting portion 41a is arranged for the cover 30 to be lifted from or covered on the container body 20; wherein the coincided surfaces 25b, 35b at the corners 25, 35 of the container base 40 are formed by fusing the coating film 12 thereon with heat, and the covering surface 31 of the cover 30 and the bottom 21 of the container body 20 have enhanced surfaces 26, 36 with a plurality of protrusions formed in one-piece. Moreover, the corners 25, 35 of the container body 20 and the cover 30 are round corners 25a, 35a.

With structures disclosed above, the present invention has an extendable container base 40 by steaming that has enhanced surfaces 26, 36 with protrusions formed in one-piece, featuring a strong structure. Also, the moisture examination for categorizing qualified products can also ensure the quality of the products and safety for the consumers, overcoming the problems in the prior art.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A manufacturing process of a one-piece paper container, comprising
a) providing a single-layer coated paper formed by having a PE coating film coated on a first surface of a base paper and leaving a second surface of the base paper exposed;
b) cutting and pressing said single-layer coated paper into an unfolded container base with a container body and a cover;
c) providing a steam room for the cut unfolded container base to be disposed therein, for the second surface of the base paper to absorb the steam and therefore soften the container base;
d) providing a thermoforming equipment to form the prototype of the container body, the cover, and a plurality of coincided surfaces at four corners to coincide and shape the container base;
e) providing an upper mold and a lower mold having depression surfaces with a pre-determined depth for thermoforming at 120° C.˜160° C. and fusing the coating film on the coincided surfaces with heat to combine with each other;
f) holding control of the period for thermoforming so that when the container body and the cover are shaped, an enhanced surface with a plurality of protrusions would form on each of the surfaces thereof; and
g) shaping the one-piece paper container and measuring the moisture thereof to decide if it is qualified.

2. The manufacturing process of a one-piece paper container as claimed in claim 1, wherein the unfolded container base in step b) comprises:
a container body including a bottom and four peripheral surfaces extending from each edge of the bottom with the edge having dotted lines and each adjacent side of the peripheral surfaces being arranged as a cut line at an oblique angle for coinciding and forming round corners of the container body;
a cover including a covering surface and four peripheral surfaces extending from each edge of the covering surface with the edge having dotted lines and each adjacent side of the peripheral surfaces being arranged as a cut line at an oblique angle for coinciding and forming round corners of the cover; and
a linking dotted lines arranged at the rear of the container body and the cover.

3. The manufacturing process of a one-piece paper container as claimed in claim 2, wherein the container body and the cover further have horizontal flange surfaces extending from the edges thereof in the thermoforming process.

4. A one-piece paper container made in the manufacturing process a s claimed in claim 1, comprising:
a container base formed by cutting and pressing a single-layer coated paper, including a container body and a cover; the single-layer coated paper is formed by having a first surface of a base paper coated on a PE coating film and leaving a second surface of the base paper exposed;
the container body having a bottom and four peripheral surfaces extending upwards from the edges of the bottom and being coincided to form the container body;
the cover having a covering surface and four peripheral surfaces extending downwards from the edges of the covering surface and being coincided to form the cover, and having a linked lifting portion arranged at the rear of the cover and the container body for the cover to be lifted from or covered on the container body;
wherein the coincided surfaces at the corners of the container base are formed by fusing the coating film thereon with heat; and
the covering surface of the cover and the bottom of the container body having enhanced surfaces with a plurality of protrusions formed in one-piece.

5. The one-piece paper container as claimed in claim 4, wherein the container body of the container base includes four peripheral surfaces extending from each edge of the bottom with the edge having dotted lines and each adjacent side of the peripheral surfaces arranged as a cut line at an oblique angle for coinciding and forming round corners of the container body; the cover of the container base includes four peripheral surfaces extending from each edge of the covering surface with the edge having dotted lines and each adjacent side of the peripheral surfaces arranged as a cut line at an oblique angle for coinciding and forming round corners of the cover; and the linking dotted lines are arranged at the rear of the container body and the cover.

6. The one-piece paper container as claimed in claim 5, wherein both the container body and the cover further have horizontal flange surfaces extending from the edges thereof in the thermoforming process.
